(19) United States
(12) Patent Application Publication
(10) Pub. No.: US 2009/0256344 A1
(43) Pub. Date: Oct. 15, 2009

(54) Recycled tire vehicle mud flap

(75) Inventor: Jerome R. Mahoney, Township of Colts Neck, NJ (US)

Correspondence Address: Deirdra M. Meagher;GlynnTech, Inc., 24 Mine Street, Flemington, NJ, 08822, US

(73) Assignee: iVoice Technologies, Inc.

(21) Appl. No.: 12/082,318

(22) Filed: Apr. 10, 2008

(51) Int. Cl. B62D 25/16

(52) U.S. Cl. 280/848

(57) ABSTRACT

A recycled tire vehicle mud flap includes a substantially flat structure having a predetermined shape and thickness for use as a mud flap, composed of fused shredded rubber from used tires and including at least one sidewall, a front, a back, and a connection mechanism adapted for connection to an outside of a vehicle in a position behind a vehicle wheel; such that the at least one vehicle mud flap is connectable via the connection mechanism to the outside of a vehicle to facilitate repression of elements hitting the motor vehicle, thereby providing enhanced protection in isolating the motor vehicle and following vehicles on a roadway from the elements.

### BACKGROUND OF INVENTION

a. Field of Invention

The invention relates generally to mud flaps for off road and road vehicles, including, but not limited to, automobiles, trucks, tractor-trailers, buses, motorcycles, ATVs, tractors, loaders, dune buggies, trikes and bikes. Specifically, the mud flap of the present invention is formed of recycled, shredded and processed tires, and may include infrastructures, such as metal or plastic rebars or grids. The method of processing the recycled tires and forming them into the mud flaps, also known as mud guards, is set forth below.

b. Description of Related Art

The following patents are relate to recycling materials and/or mud flaps:

U.S. Pat. No. 5,801,205 to Nishibori et al. describes a reprocessed resin which decreases volume of a thermoset resin foamed material recovered from waste of various resin products and moldably form said thermoset resin foamed material into various molded articles to thereby effectively recover and reprocess the thermoset resin foamed material, a reprocessing method therefore and a method for molding a molded article formed of said reprocessed resin. A pulverized resin to be processed formed of a thermoset resin foamed material along with a thermoplastic resin molding material are applied with a stirring impact force to produce shearing heat generation based on the stirring impact force and are gelled and blended by the shearing heat generation. In this process, the thermoplastic resin molding material is adhered so as to cover the whole surface of the individual pulverized resin to be processed and cooled and granulated to have 15 mm or less of particle diameter to thereby decrease volume by 0.3 or more in bulk specific gravity whereby a reprocessed resin imparting a good flowability is formed to maintain a good blended state at the time of molding such as extrusion molding, injection molding or the like, and a suppressing force is applied to a molded article to increase a density of an extruded material to mold a molded article of uniform and high density.

U.S. Pat. No. 5,697,645 to Nagler describes a vehicle mud guard made from discarded tired connected to the vehicle body. The tires are recycled and easily attached to the T-flange.

U.S. Pat. No. 4,453,728 to Verge describes a splash guard or mud guard for vehicles. The assembly has a lower section pivotally secured to an upper section and includes oppositely wound axially spaced helical springs with a mechanism to independently adjust the tension of the springs which permits the lower flap section to pivot equally in either forward or rearward direction under equal tension.

Notwithstanding the prior art, the present invention is neither taught nor rendered obvious thereby.

### SUMMARY OF INVENTION

The present invention recycled tire vehicle mud flap includes: a substantially flat structure having a predetermined shape and thickness for use as a mud flap, composed of fused shredded rubber from used tires and including at least one sidewall, a front, a back, and connection means adapted for connection to an outside of a vehicle in a position behind a vehicle wheel; such that the at least one vehicle mud flap is connectable via the connection means to the outside of a vehicle to facilitate repression of elements hitting the motor vehicle, thereby providing enhanced protection in isolating the motor vehicle and following vehicles on a roadway from the elements.

In some preferred embodiments of the present invention recycled tire vehicle mud flap, the connection means is a plurality of apertures on the structure.

In some preferred embodiments of the present invention recycled tire vehicle mud flap, the plurality of apertures is located on an upper portion of the structure of the recycled tire vehicle mud flap.

In some preferred embodiments of the present invention recycled tire vehicle mud flap, the plurality of apertures is located on an outer side edge of the structure of the recycled tire vehicle mud flap.

In some preferred embodiments of the present invention recycled tire vehicle mud flap, the plurality of apertures is located on an upper portion of the structure of the recycled tire vehicle mud flap and an outer side edge of the structure of the recycled tire vehicle mud flap.

In some preferred embodiments of the present invention recycled tire vehicle mud flap, the structure further includes a support infrastructure selected from the group consisting of wire, mesh, grid strips and rods.

In some preferred embodiments of the present invention recycled tire vehicle mud flap, the support infrastructure is a metal support infrastructure.

In some preferred embodiments of the present invention recycled tire vehicle mud flap, the support infrastructure is a plastic support infrastructure.

In some preferred embodiments of the present invention recycled tire vehicle mud flap, the connection means is adapted to receive threaded fasteners.

In some preferred embodiments of the present invention recycled tire vehicle mud flap, the structure has a shape that is rectangular with a projection portion extending from the top of the structure.

In some different embodiments of the present invention the recycled tire vehicle mud flap includes: at least one vehicle mud flap composed entirely of fused shredded rubber from used tires, said shredded rubber having a maximum cross section size no greater than 0.015 inches, and including at least one sidewall, a front, a back, and connection means adapted for connection to an outside of a motor vehicle in a position behind a vehicle wheel, wherein the at least one vehicle mud flap is adapted to be connected to a mounting plate; such that the at least one vehicle mud flap facilitates repression of elements hitting the motor vehicle, thereby providing enhanced protection in isolating the motor vehicle and following vehicles on a road from the elements.

In some preferred embodiments of the present invention recycled tire vehicle mud flap described in paragraph [00017] above, the connection means is a plurality of apertures on the structure.

In some preferred embodiments of the present invention recycled tire vehicle mud flap described in paragraph [00017] above, the plurality of apertures is located on an upper portion of the structure of the recycled tire vehicle mud flap.

In some preferred embodiments of the present invention recycled tire vehicle mud flap described in paragraph [00017] above, the plurality of apertures is located on an outer side edge of the structure of the recycled tire vehicle mud flap.

In some preferred embodiments of the present invention recycled tire vehicle mud flap described in paragraph [00017] above, the plurality of apertures is located on an upper portion of the structure of the recycled tire vehicle mud flap and an outer side edge of the structure of the recycled tire vehicle mud flap.

In some preferred embodiments of the present invention recycled tire vehicle mud flap described in paragraph [00017] above, the structure further includes a support infrastructure selected from the group consisting of wire, mesh, grid strips and rods.

In some preferred embodiments of the present invention recycled tire vehicle mud flap described in paragraph [00017] above, the support infrastructure is a metal support infrastructure.

In some preferred embodiments of the present invention recycled tire vehicle mud flap described in paragraph [00017] above, the support infrastructure is a plastic support infrastructure.

In some preferred embodiments of the present invention recycled tire vehicle mud flap described in paragraph [00017] above, the connection means is adapted to receive threaded fasteners.

In some preferred embodiments of the present invention recycled tire vehicle mud flap described in paragraph [00017] above, the structure has a shape that is rectangular with a projection portion extending from the top of the structure.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is a front perspective view of an embodiment of a recycled tire vehicle mud flap according to the present invention;

FIG. 2 is a front view of another embodiment of the recycled tire vehicle mud flap according to the present invention;

FIG. 3 is a front view of another embodiment of the recycled tire vehicle mud flap according to the present invention that includes a support infrastructure; and,

FIG. 4 is a perspective view of another embodiment of the recycled tire vehicle mud flap according to the present invention, illustrating a mounting arrangement.

### DETAILED DESCRIPTION OF THE EMBODIMENTS

The fused shredded rubber from used tires, which composes the present invention vehicle mud flap, may be obtained as shredded rubber from waste dumps and recycling facilities providing scrap tires. A mold is previously made allowing for the desired shape and attachment means requirements, typically a plurality of orifices. The scrap tires are cut or shredded to a predetermined size that is manageable for processing and are heat-processed and placed into the mold through injection and/or pressing. Manageable sizes are typically below about 0.15 inches and preferably about 0.10 inches and less in maximum cross section. The shredded rubber may be heated prior to or after being placed in the mold, or both. Upon cooling, the mod is removed to provide the vehicle mud flap. Heating may be for a few minutes or longer and heat temperatures may be within any temperature or range wherein the shredded tire rubber begins to melt, but should not be fully melted. The objective is to fuse the cut or shredded pieces so that they fuse together and form a single structure, in many cases with a resulting grainy heterogeneous topography wherein the fused pieces can be seen.

The use of the shredded rubber from used tires provides greening by saving the environment from the breakdown of the rubber and potential fire hazards by chemical reactions of the rubber with soil and air. Thus, a waste disposal problem and an environmental problem are eliminated by use of scrap tires.

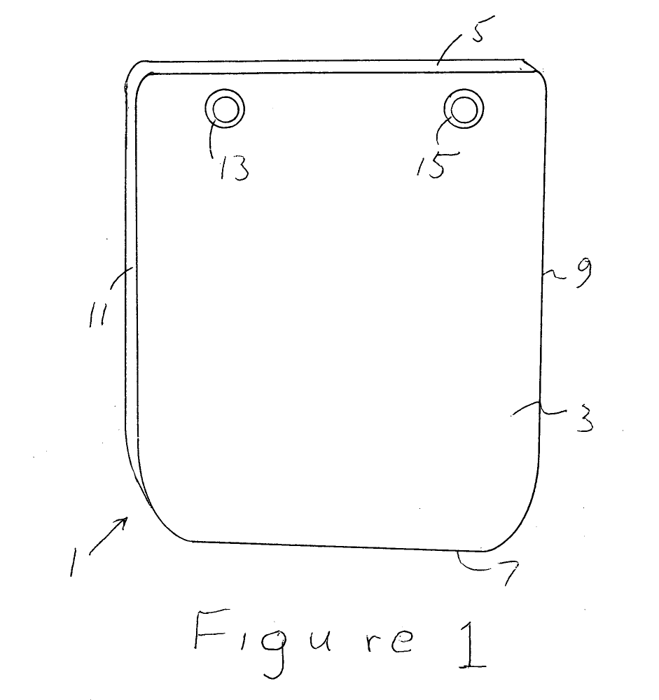

Referring now to the drawings, beginning with FIG. 1, FIG. 1 is a front perspective view of an embodiment of a recycled tire vehicle mud flap 1 according to the present invention. It has a generally flat surface with a rectangular structure and rounded corners. The structure is formed of fused tire shred pieces made from recycled tires shredded down to pieces having a maximum cross section of about 0.05 to about 0.1 inches. The structure includes a front 3, a back (not shown), a top 5 and a bottom 7, as well as sides 11 and 9. Attachment means for attachment to a vehicle, in this example, are two bolt orifices 13 and 15. They are used in conjunction with nuts, bolts, washers and springs, or spring washers for attachment to the wheel areas of vehicles. Thus, mud flap 1 and other present invention mud flaps described below may be bolted, screwed or otherwise attached to wheel wells, vehicle undersides, support frames or otherwise, so as to be positioned behind one or more wheels to reduce airborne elements from the tires, such as rocks, mud, water, snow, etc.

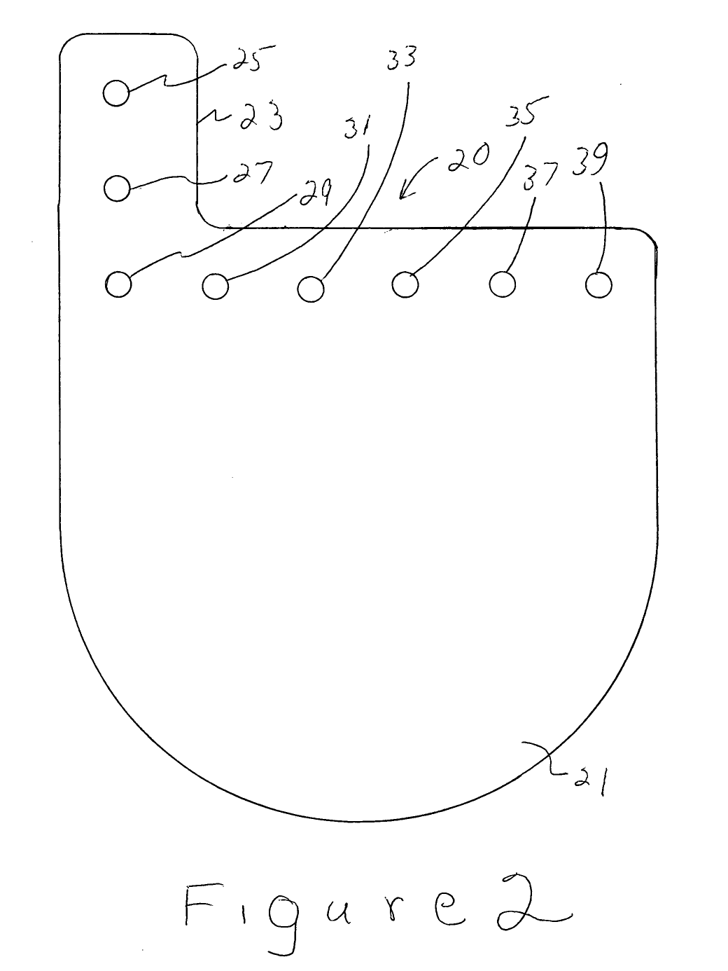

FIG. 2 is a front view of another embodiment of the recycled tire vehicle mud flap 20 according to the present invention. Mud flap 20 has a solid fused, recycled, shredded tire substantially flat structure 21. This is formed from partially melted and fused shredded pieces of recycled tires having a cross section no greater than 0.15 inches. Structure 21 is rectangular with a rounded corner and includes an upward projection 23 to accommodate a vehicle having an L-shaped attachment bracket using one or more vertical orifices 25, 27 and 29, and using one or more horizontal orifices 31, 33, 35, 37 and 39.

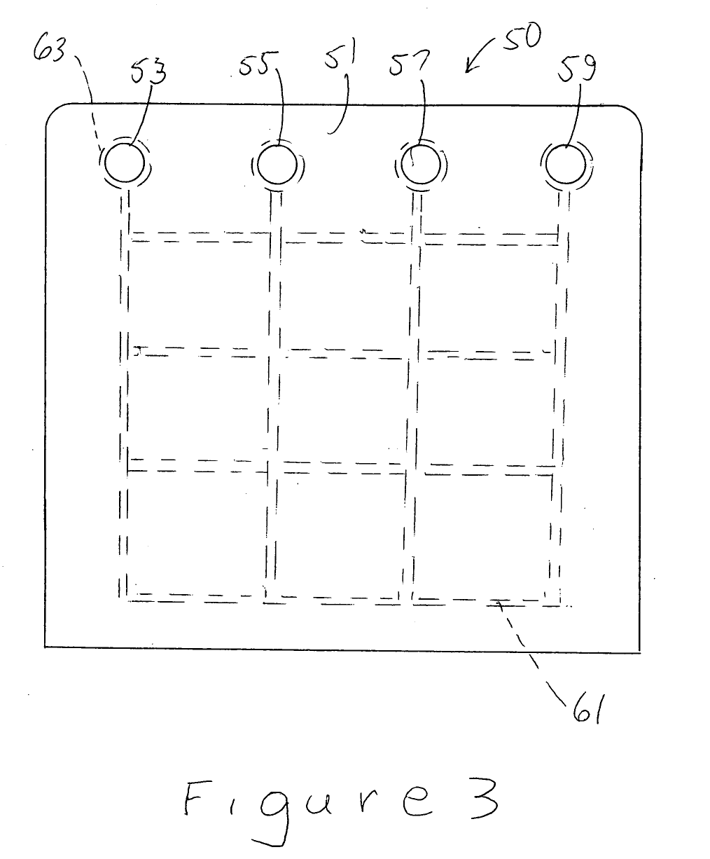

FIG. 3 is a front view of another embodiment of the recycled tire vehicle mud flap 50 according to the present invention that includes a support infrastructure 61. Support infrastructure 61 may be wires, rods, strips or interconnected grids or meshes that may be made of plastic or metal or combinations thereof. Support infrastructure 61 includes embedded washers such as washer 63 to surround attachment orifices such as orifice 53, for extra support. The support infrastructure 61 is embedded into the mud flap during the molding process by placing the shredded tire material and the mold to a predetermined thickness, placing the support infrastructure into the mold and then placing additional shredded tire material on top of the support infrastructure so that when the material is partially melted and fused, the support infrastructure is permanently embedded into the mud flap.

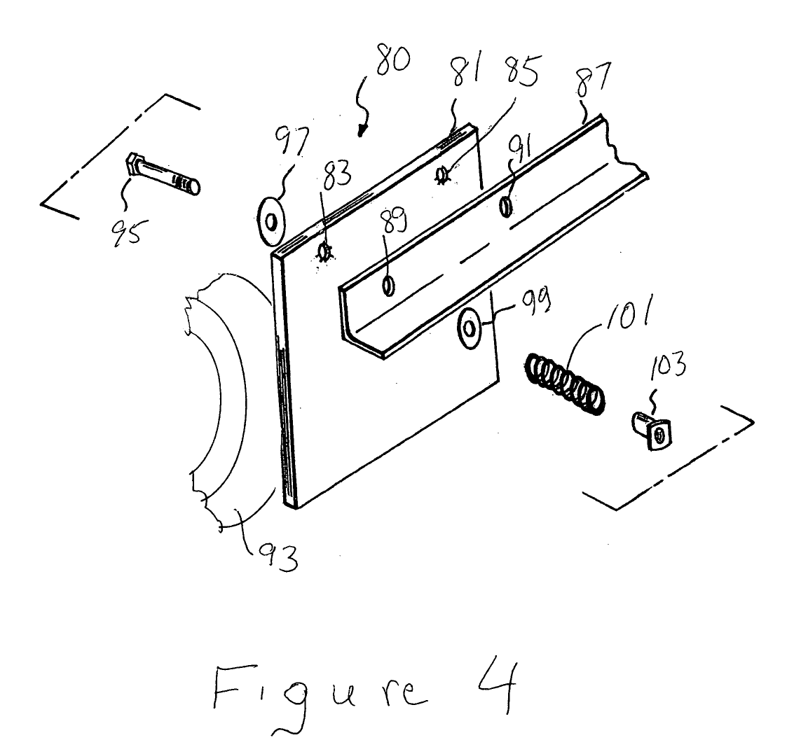

FIG. 4 is a perspective view of another embodiment of the recycled tire vehicle mud flap 80 according to the present invention, illustrating a mounting arrangement. In this case, recycled tire vehicle mud flap 80 has attachment orifices 83 and 85 near its top 81 that align with attachment bracket 87 orifices 89 and 91. Attachment bracket 87 is connected to a vehicle such as a truck above and behind tire 93. Recycled tire vehicle mud flap 80 is attached to the back of attachment bracket 87 by an attachment set of components that is now described with respect to mud flap orifice 83 and bracket orifice 89, but applies as well to mud flap orifice 85 and bracket orifice 91.

In FIG. 4, the attachment components are shown in an exploded view. Bolt 95 is past through washer 97 and then through mud guard orifice 83. Bolt 95 is next past through bracket orifice 89 washer 99 and spring 91. Compression lock nut 103 passes into spring 101 and threads onto bolt 95 for secure attachment of mud guard 80 to the vehicle.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, in some preferred embodiments, before being melted and fused, the shredded rubber from used tires may be intermixed with an appropriate binding material, such as those used in the insides of a baseball, or any other available binder that works with rubber used in tires.

What is claimed is:

1. A recycled tire vehicle mud flap which comprises:
a substantially flat structure having a predetermined shape and thickness for use as a mud flap, composed of fused shredded rubber from used tires and including at least one sidewall, a front, a back, and connection means adapted for connection to an outside of a vehicle in a position behind a vehicle wheel;
such that said at least one vehicle mud flap is connectable via said connection means to the outside of a vehicle to facilitate repression of elements hitting said motor vehicle, thereby providing enhanced protection in isolating said motor vehicle and following vehicles on a roadway from said elements.

2. The recycled tire vehicle mud flap of claim 1 wherein said connection means is a plurality of apertures on said structure.

3. The recycled tire vehicle mud flap of claim 2 wherein said plurality of apertures is located on an upper portion of said structure of said recycled tire vehicle mud flap.

4. The recycled tire vehicle mud flap of claim 2 wherein said plurality of apertures is located on an outer side edge of said structure of said recycled tire vehicle mud flap.

5. The recycled tire vehicle mud flap of claim 2 wherein said plurality of apertures is located on an upper portion of said structure of said recycled tire vehicle mud flap and an outer side edge of said structure of said recycled tire vehicle mud flap.

6. The recycled tire vehicle mud flap of claim 1 wherein said structure further includes a support infrastructure selected from the group consisting of wire, mesh, grid strips and rods.

7. The recycled tire vehicle mud flap of claim 1 wherein said support infrastructure is a metal support infrastructure.

8. The recycled tire vehicle mud flap of claim 1 wherein said support infrastructure is a plastic support infrastructure.

9. The recycled tire vehicle mud flap of claim 1 wherein said connection means is adapted to receive threaded fasteners.

10. The recycled tire vehicle mud flap of claim 1 wherein said structure has a shape that is rectangular with a projection portion extending from the top of said structure.

11. A recycled tire vehicle mud flap which comprises:
a substantially flat structure having a predetermined shape and thickness for use as a mud flap, composed of fused shredded rubber from used tires, said shredded rubber having a maximum cross section size no greater than 0.015 inches, and including at least one sidewall, a front, a back, and connection means adapted for connection to an outside of a vehicle in a position behind a vehicle wheel;
such that said at least one vehicle mud flap is connectable via said connection means to the outside of a vehicle to facilitate repression of elements hitting said motor vehicle, thereby providing enhanced protection in isolating said motor vehicle and following vehicles on a roadway from said elements.

12. The recycled tire vehicle mud flap of claim 11 wherein said connection means is a plurality of apertures on said structure.

13. The recycled tire vehicle mud flap of claim 12 wherein said plurality of apertures is located on an upper portion of said structure of said recycled tire vehicle mud flap.

14. The recycled tire vehicle mud flap of claim 12 wherein said plurality of apertures is located on an outer side edge of said structure of said recycled tire vehicle mud flap.

15. The recycled tire vehicle mud flap of claim 12 wherein said plurality of apertures is located on an upper portion of said structure of said recycled tire vehicle mud flap and an outer side edge of said structure of said recycled tire vehicle mud flap.

16. The recycled tire vehicle mud flap of claim 11 wherein said structure further includes a support infrastructure selected from the group consisting of wire, mesh, grid strips and rods.

17. The recycled tire vehicle mud flap of claim 11 wherein said support infrastructure is a metal support infrastructure.

18. The recycled tire vehicle mud flap of claim 11 wherein said support infrastructure is a plastic support infrastructure.

19. The recycled tire vehicle mud flap of claim 11 wherein said connection means is adapted to receive threaded fasteners.

20. The recycled tire vehicle mud flap of claim 11 wherein said structure has a shape that is rectangular with a projection portion extending from the top of said structure.
